(19) United States
(12) Patent Application Publication
(10) Pub. No.: US 2019/0362340 A1
(43) Pub. Date: Nov. 28, 2019

(54) SECURE MULTIPLE CRYPTOCURRENCY WALLET AND METHODS OF USE THEREOF

(71) Applicant: BITFI, INC., Asheville, NC (US)

(72) Inventors: MICHAEL STRONG, FLETCHER, NC (US); DANIEL KHESIN, BOCA RATON, FL (US)

(21) Appl. No.: 16/417,699

(22) Filed: May 21, 2019

Related U.S. Application Data
(60) Provisional application No. 62/687,823, filed on Jun. 21, 2018.
(60) Provisional application No. 62/676,289, filed on May 25, 2018.

(51) Int. Cl. G06Q 20/36; G06Q 20/06; G06Q 20/38; G06Q 20/32

(52) U.S. Cl. CPC G06Q 20/3674; G06Q 20/065; G06Q 20/325; G06Q 20/3829; G06Q 20/3676

(57) ABSTRACT

The present invention provides a secure hardware wallet device, a wallet assembly, system and method for transacting a plurality of cryptocurrencies, the hardware wallet device including means to enable a user to input a secret phrase, a processor adapted to calculate at least one private key to enable a transaction to be performed wirelessly over a communications network to or from the hardware wallet device, wherein neither of the secret phrase nor the at least one private key is stored on the hardware wallet device.

### FIELD OF THE INVENTION

The present invention relates generally to devices and methods for secure cryptocurrency storage and use, and more specifically to novel secure wallets for multiple cryptocurrency storage and use.

### BACKGROUND OF THE INVENTION

The world economic markets have turned from precious stones and metals to national currencies. The national paper currencies were often backed by a gold standard. Thereafter, the gold standard backing was removed.

With development of the internet and virtual markets, many different blockchains with a decentralized ledger have been developed. These are termed “cryptocurrencies”. There is a tremendous security issue with cryptocurrencies. As these currencies gain market volume and value against a national currency, such as the US dollar, an increasing incentive exists for hackers and thieves to capture and steal virtual currencies/cryptocurrencies.

There is thus a great need for secure personalized wallets, in which individuals can store their virtual currency and retrieve it for use and transactions, without fear of losing their value/being stolen.

A number of cryptocurrency wallets exist, such as Trezor, Ledger Nano, Keepkey and the like. However, some of these suffer from at least one or more of the following disadvantages:
a) One cannot view all crypto assets/currencies in one place without going into many individual folders;
b) They require storage of a large number of secure words;
c) They store their private key and/or password/pincode on the device/wallet;
d) They require a specific wallet for a specific cryptocurrency;
e) the backup of the wallet can be destroyed in a fire or flood;
f) they are at risk of a “man-in-the middle attack”, particularly if purchased from a third-party vendor;
g) They do not support privacy coins (such as Monero, due to its complex algorithm);
h) They require both a backup phrase and a password; and
i) They require a wired connection to another device or computer.

US20150324789A1 discloses a method, in which an encrypted request to transfer a requested amount of cryptocurrency from a user address to a destination address is received. The request includes a destination address, a requested amount, a user device encryption key and biometric data. A partially signed transaction to transfer a requested amount of cryptocurrency from the user address to the destination address is also received. The partially signed transaction is cryptographically signed, and a multi-signed transaction is broadcast to a cryptocurrency network to transfer the requested amount of cryptocurrency from the user address to the destination address.

US20150262176A1 describes a system and method for transaction of bitcoins. Bitcoin can be sent to an email address. No miner's fee is paid by a host computer system. Hot wallet functionality is provided that transfers values of some Bitcoin addresses to a vault for purposes of security. A private key of a Bitcoin address of the vault is split and distributed to keep the vault secure. Instant exchange allows for merchants and customers to lock in a local currency price. A vault has multiple email addresses to authorize a transfer of bitcoin out of the vault. User can opt to have private keys stored in locations that are under their control. A tip button rewards content creators for their efforts. A bitcoin exchange allows for users to set prices that they are willing to sell or buy bitcoin and execute such trades.

US20150227897A1 discloses a method of making, securing, and using a tangible Cryptocurrency wallet, wherein the tangible Cryptocurrency wallet is a printable medium that displays a public key that is in visible ink and that conceals a private key in invisible ink. The tangible Cryptocurrency wallet can be used in public by the user, for the private key can only be disclosed by the owner of the tangible Cryptocurrency wallet when the owner illuminates the private key with a light source that has a specific wavelength. The tangible Cryptocurrency wallet is a wallet that can be made of paper or of any material in which visible and invisible ink can be recorded.

US20150356555A1 describes a system for implementing at least one cryptocurrency transaction at a point-of-sale by using a mobile terminal. The system is operable to provide authentication for implementing the one or more cryptocurrency transactions, wherein the system is operable to send at least one authentication request for the at least one cryptocurrency transaction from a payment terminal to a payment service hosted via one or more virtual computing machines, wherein the payment service is operable to provide a request for a PIN code at the mobile terminal; to send the PIN code from the mobile terminal via a secure channel to open a vault in the one or more virtual machines, wherein the vault contains one or more private keys (PKI) which are useable for authenticating the at least one cryptocurrency transaction; and to confirm execution of the at least one cryptocurrency transaction to at least the payment terminal.

There still remains a need for improved secure personalized wallets, in which individuals can store their virtual currency and retrieve it for use and transactions, as well as user authentication systems and methods.

### SUMMARY OF THE INVENTION

It is an object of some aspects of the present invention to provide improved devices and methods for secure cryptocurrency storage and use.

In some embodiments of the present invention, improved methods and systems, including novel secure personal wallets for cryptocurrency storage and use, are provided.

In other embodiments of the present invention, a method and system is described for providing improved novel secure hardware wallet devices for multiple cryptocurrency storage and use.

The present invention provides a secure hardware wallet device, a wallet assembly, system and method for transacting a plurality of cryptocurrencies, the hardware wallet device including means to enable a user to input a secret phrase, a processor adapted to calculate at least one private key to enable a transaction to be performed wirelessly over a communications network to or from the hardware wallet device, wherein neither the secret phrase nor the at least one private key is stored on the hardware wallet device.

The present invention further provides a hardware wallet device and method for storing and transacting a plurality of cryptocurrencies, the hardware wallet device including a touchscreen display or keyboard, configured to enable a user to input a secret phrase, the hardware device further including a processor adapted to run an algorithm to calculate a private key for controlling some or all of the plurality of cryptocurrencies and a Wifi connector for connection to the internet.

According to further embodiments of the present invention, there is provided a hardware wallet device adapted to be synched to a dashboard, displayed on a second device over a communication network, such as the internet. The second device, such as a smartphone or computer, is configured to connect directly to a blockchain (of one or more of the plurality of cryptocurrencies) to enable the transactions to be performed wirelessly over a communications network to and from the hardware wallet device.

There is thus provided according to an embodiment of the present invention, a cryptocurrency hardware wallet device for storing and transacting a plurality of cryptocurrencies, the hardware wallet device including;
a. an inputting means, adapted for inputting a secret phase of a user;
b. a processor adapted to calculate at least one private key using an algorithm; and
c. means for connecting to a communication network to enable transactions to be performed wirelessly over the communications network to and from the hardware wallet device using said at least one private key.

There is thus provided according to an embodiment of the present invention, a cryptocurrency hardware wallet device for storing and transacting a plurality of cryptocurrencies, the hardware wallet device including;
a. an inputting screen or keyboard, adapted for inputting a secret phase of a user;
b. a processor, adapted to calculate at least one private key using an algorithm, activated by said secret phrase; and
c. Wifi connection means to enable transactions to be performed wirelessly over a communications network to and from the hardware wallet device, using one or more of said at least one private key.

There is thus provided according to an embodiment of the present invention, a cryptocurrency hardware wallet device for storing and transacting a plurality of cryptocurrencies, the hardware wallet device including;
a. a touchscreen display or keyboard configured to enable a user to input a secret phrase;
b. a processor adapted to calculate a private key using an algorithm; and
c. means for connecting said hardware wallet device to a communications network, to enable transactions to be performed wirelessly over the communications network to and from the hardware wallet device.

There is thus provided according to an embodiment of the present invention, a cryptocurrency system for storing and transacting a plurality of cryptocurrencies, the system including;
a) at least one cryptocurrency hardware wallet device as described herein;
b) at least one computer, processor or communication device adapted to be synched with said at least one hardware wallet device.

There is thus provided according to an embodiment of the present invention, a cryptocurrency system for storing and transacting a plurality of cryptocurrencies, the system including;
a) at least one cryptocurrency hardware wallet device as described herein;
b) at least one computer, processor or communication device adapted to be synched with said at least one hardware wallet device, said communication device configured to enable a user to view a dashboard at an internet site for viewing the plurality of cryptocurrencies using a private key for accessing all of the plurality of cryptocurrencies; and wherein said computer, processor or communication device is configured to update transactions to and from the at least one hardware wallet device in the plurality of cryptocurrencies and to provide a real-time update of a balance of the plurality of cryptocurrencies on the dashboard.

There is thus provided according to an embodiment of the present invention, a cryptocurrency system for storing and transacting a plurality of cryptocurrencies, the system including;
a) at least one cryptocurrency hardware wallet device as described herein;
b) at least one computer, processor or communication device adapted to be synched with said at least one hardware wallet device, said communication device configured to enable a user to view a dashboard, optionally at an internet site, for viewing the plurality of cryptocurrencies using a private key for accessing all of the plurality of cryptocurrencies; and wherein said computer, processor or communication device is configured to update transactions to and from the at least one hardware wallet device in the plurality of cryptocurrencies and to provide a real-time update of a balance of the plurality of cryptocurrencies on the dashboard.

There is thus provided according to an embodiment of the present invention, a cryptocurrency system for storing and transacting a plurality of cryptocurrencies, the system including;
a. at least one hardware wallet device, each device comprising:
   i. a touchscreen display or keyboard configured to enable a user to input a secret phrase;
   ii. a processor adapted to calculate a private key using an algorithm; and
   iii. means for connecting said hardware wallet device to a communications network, to enable transactions to be performed wirelessly over the communications network to and from the hardware wallet device; and
b. at least one computer, processor or communication device adapted to be synched with said at least one hardware wallet device, said communication device configured to enable a user to view a dashboard for viewing the plurality of cryptocurrencies using the private key for accessing all of the plurality of cryptocurrencies; and wherein said computer, processor or communication device is configured to update transactions to and from the at least one hardware wallet device in the plurality of cryptocurrencies and to provide a real-time update of a balance of the plurality of cryptocurrencies on the dashboard.

There is thus provided according to an embodiment of the present invention, a cryptocurrency system for storing and transacting a plurality of cryptocurrencies, the system including;
a. a plurality of hardware wallet devices, each hardware wallet device comprising:
   i. a touchscreen display or keyboard configured to enable a user to input a secret phrase;
   ii. a processor adapted to calculate a private key using an algorithm; and
   iii. means for connecting said hardware wallet device to a communications network, to enable transactions to be performed wirelessly over the communications network to and from the hardware wallet device; and
b. at least one computer, processor or communication device adapted to be synched with at least one of said plurality of hardware wallet devices, said communication device configured to enable a user to view a dashboard at an internet site for viewing the plurality of cryptocurrencies using the private key for accessing all of the plurality of cryptocurrencies; and wherein said computer, processor or communication device is configured to update transactions to and from the at least one hardware wallet device in the plurality of cryptocurrencies and to provide a real-time update of a balance of the plurality of cryptocurrencies on the dashboard.

The system typically further comprises software for enabling the transactions via a computer, mobile device or processor.

There is thus provided according to an embodiment of the present invention, a cryptocurrency hardware wallet device for storing and transacting a plurality of cryptocurrencies, the hardware wallet device including;
a. a touchscreen display configured to enable a user to input a secret phrase;
b. a processor configured to activate an algorithm to calculate at least one private key responsive to the secret phrase; and
c. a Wifi connector adapted to enable the transactions to be performed wirelessly over a communications network to and from the hardware wallet device;

wherein said hardware wallet device is configured to communicate wirelessly with a processor or mobile communications device comprising:
i. a screen for viewing a dashboard for enabling view of the plurality of cryptocurrencies using the at least one private key for accessing one or more of all of the plurality of cryptocurrencies; and
ii. software for enabling the transactions via the processor.

Additionally, according to an embodiment of the present invention, the at least one private key includes a plurality of private keys.

Moreover, according to an embodiment of the present invention, the plurality of private keys includes tens of private keys, hundreds of private keys, thousands of private keys, or millions of private keys.

The systems and devices of the present invention provide a global payments technology to enable businesses and consumers to participate in the digital currency economy. The hardware wallet systems of the present invention include numerous innovations, including a truly unhackable, open-source hardware wallet device for cryptocurrency and crypto assets. Users can access the hardware wallet device using a secret phrase that calculates private keys, which do not have to be stored on any hardware or software. The hardware wallet devices of the present invention provide impenetrable security, with download-free and WiFi-enabled operation, allowing users to participate in the digital asset economy without any risk of loss.

The hardware wallet device of the present invention is a first unhackable, open source hardware wallet, used with an accompanying dashboard that features wireless setup and support for many popular cryptocurrencies and crypto assets, including Monero, a fully decentralized private cryptocurrency that has previously never had a hardware wallet solution.

The systems, devices and methods of the present invention are constructed and configured to accelerate adoption of decentralized assets by making interaction with these assets seamless and without risk.

The hardware wallet device offers more security than any other type of storage (including cold storage) without the need for technical skill, downloads or app installations to set up, requiring only a wireless connection. Once the hardware wallet device is set up, the device automatically receives the latest software updates thus completely eliminating any possibility for a user to download corrupt software or fall prey to phishing attacks.

The hardware wallet devices of the present invention are configured to receive additional support over time for additional cryptocurrencies and crypto assets. The hardware wallet devices are configured to be fully functional for additional/new cryptocurrencies and crypto assets, with the system configured to automatically update algorithm(s) onboard the hardware wallet devices, to enable new cryptocurrencies/assets to automatically appear in the wallets of all users. In this way, a single purchase of the hardware wallet guarantees that wallet holders/users always have access to its latest technology and updates, making these hardware wallet devices a secure, long-term investment.

The hardware wallet devices of the present invention provide a completely secure and convenient storage solution to drive rapid adoption of decentralized blockchain assets.

The hardware wallet devices of the present invention allow wallet holders/users to store an unlimited amount of funds, without possibility of loss or theft, by utilizing a proprietary and open-source algorithm that calculates the private key with a powerful onboard CPU from the user's own unique secret phrase.

According to some embodiments of the present invention, the private key only exists for a short period of time, such as, but not limited to, ten minutes, five minutes one minute, ten seconds, one second, or a fraction of a second.

According to some embodiments of the present invention, the private key only just long enough to approve the transaction and is never stored anywhere. The user-created phrase is impossible for others to guess but easy for the wallet holder to memorize.

Unlike other wallets, the hardware wallet device of the present invention cannot be tampered with. If it is ever lost, stolen, taken apart and forensically analyzed, the private keys cannot be retrieved, making the wallet safe to purchase from anyone within the network of authorized distribution dealers.

According to some embodiments of the present invention, the algorithm is completely open source, thus users can easily obtain their private keys without any reliance on 3rd parties.

Furthermore, instead of having to access each currency from individual folders or multiple wallets, users can view and control all of their digital currencies and assets in one place via a dashboard, as described herein.

The systems of the present invention enable use of one or more private keys via the hardware wallet device to enable users to view all balances at a glance and quickly switch from one cryptocurrency to another, whether for personal or business use, much like using an ATM machine.

The hardware wallet devices of the present invention provide features for support of Ethereum, allowing users to view both their Ethereum balance and access tokens in one place rather than using third-party services.

Optionally, according to an embodiment of the present invention, the mobile communications device is configured to enable the transactions only when said hardware wallet device is in proximity with said mobile communications device.

Further, according to an embodiment of the present invention, the private key is not stored either remotely or locally in the wallet.

Moreover, according to another embodiment of the present invention, the private key is generated upon a user request.

Typically, according to another embodiment of the present invention, the private key is for one-off use.

Furthermore, according to an embodiment of the present invention, the plurality of cryptocurrencies includes at least one of Bitcoin, Etherium, Monero, a privacy coin, a current cryptocurrency, a future cryptocurrency and combinations thereof.

Importantly, according to an embodiment of the present invention, the plurality of cryptocurrencies includes all of Bitcoin, Etherium, Monero, a privacy coin, a current cryptocurrency, a future cryptocurrency and combinations thereof.

Additionally, according to an embodiment of the present invention, the wallet is configured to automatically update the software via the communications network from a remote node.

Furthermore, according to an important embodiment of the present invention, the user is not required to download or update anything.

Further, according to an important embodiment of the present invention, the cryptocurrency wallet further includes a firewall configured to block an unauthorized connection with the wallet from at least one of a node, a server, a second wallet, a wireless communication device, a wired communication device and combinations thereof.

Additionally, according to an embodiment of the present invention, the cryptocurrency wallet further includes a casing for housing the touchscreen display, the dashboard, and the Wifi connector.

Further, according to an embodiment of the present invention, the cryptocurrency wallet includes a battery.

According to an embodiment of the present invention, the casing further includes;
a. an on/off button; and
b. a USB port.

There is thus provided according to another embodiment of the present invention, a method for transacting cryptocurrency employing a multiple-cryptocurrency hardware wallet device, the method including;
a. activating the multiple-cryptocurrency hardware wallet device using a secret phrase on the wallet;
b. calculating a private key; and
c. performing a wireless cryptocurrency transaction from the hardware wallet device employing the private key.

There is thus provided according to another embodiment of the present invention, a method for transacting cryptocurrency employing a multiple-cryptocurrency hardware wallet device, the method including;
a. activating the multiple-cryptocurrency wallet using a secret phrase inputted onto a screen on the hardware wallet device;
b. calculating a private key; and
c. performing a wireless cryptocurrency transaction from the hardware wallet device, activated by the private key.

There is thus provided according to another embodiment of the present invention, a method for transacting cryptocurrency employing a multiple-cryptocurrency hardware wallet device, the method including;
a. activating the multiple-cryptocurrency wallet using a secret phrase inputted onto a screen on the hardware wallet device;
b. calculating a private key;
c. performing a wireless cryptocurrency transaction from the hardware wallet device, activated by the private key; and
d. displaying a real-time update of a balance of a plurality of cryptocurrencies in the hardware wallet device on a dashboard.

There is thus provided according to another embodiment of the present invention, a method for transacting cryptocurrency employing a multiple-cryptocurrency hardware wallet device, the method including;
a. activating the multiple-cryptocurrency wallet using a secret phrase on the wallet;
b. calculating a private key;
c. performing a wireless cryptocurrency transaction from the hardware wallet device employing the private key;
d. seamlessly updating the wallet of the transaction; and
e. displaying a real-time update of a balance of a plurality of cryptocurrencies in the hardware wallet device on a dashboard.

Additionally, according to an embodiment of the present invention, the dashboard is displayed on a mobile communication device or on a computer.

There is thus provided according to another embodiment of the present invention, a method for transacting cryptocurrency employing a multiple-cryptocurrency hardware wallet device, the method including;
a. activating the multiple-cryptocurrency hardware wallet device using a secret phrase via a touchscreen display on the wallet;
b. calculating a private key;
c. wirelessly synching the multiple-cryptocurrency hardware wallet device a computer or communication device; and
d. performing a wireless cryptocurrency transaction to or from the hardware wallet device employing the private key by connecting the device to a blockchain.

There is thus provided according to another embodiment of the present invention, a method for transacting cryptocurrency employing a multiple-cryptocurrency wallet, the method including;
a. synching the multiple-cryptocurrency hardware wallet device with a dashboard, displayed on a computer or communication device (smartphone);
b. activating the multiple-cryptocurrency hardware wallet device using a user personalized offline phrase via a touchscreen display on the hardware wallet device;
c. calculating a private key;
d. performing a wireless cryptocurrency transaction to or from the hardware wallet device employing the private key;
e. seamlessly updating the hardware wallet device of the transaction; and
f. displaying a real-time update of a balance of a plurality of cryptocurrencies in the device on the dashboard of the computer or of the smartphone.

Additionally or alternatively, some of the order of some of steps of the method may be changed.

Additionally or alternatively, some of steps of the method may be omitted.

Furthermore, according to an embodiment of the present invention, the multiple cryptocurrency method includes at least one of Bitcoin, Etherium, Monero, a privacy coin, a current cryptocurrency, a future cryptocurrency and combinations thereof.

Importantly, according to an embodiment of the present invention, the multiple cryptocurrency method all of Bitcoin, Etherium, Monero, a privacy coin, a current cryptocurrency, a future cryptocurrency and combinations thereof.

Additionally, according to an embodiment of the present invention, the method further includes automatically updating software running the hardware wallet device via a wireless communications network.

Moreover, according to an embodiment of the present invention, the method further includes blocking an unauthorized connection with the wallet from at least one of a node, a server, a second wallet, a wireless communication device, a wired communication device and combinations thereof via a firewall installed on the wallet.

Importantly, according to an embodiment of the present invention, the method further includes sharing of processing tasks with a server for crypto processing functions so as to reduce a calculation time of the transaction.

Typically, according to an embodiment of the present invention, the calculation time is reduced to less than one minute.

Additionally, according to an embodiment of the present invention, the calculation time is reduced to less than 15 seconds.

There is thus provided according to another embodiment of the present invention, a software product, the product configured for transacting cryptocurrency employing a multiple-cryptocurrency hardware wallet device, the product including a processor-readable medium in which program instructions are stored, which instructions, when read by a processor, cause the processor to;
a. activate the multiple-cryptocurrency wallet, comprising a hardware wallet device and a computer or smartphone, using a secret (offline) phrase via the hardware wallet device;
b. calculate a private key;
c. perform a wireless cryptocurrency transaction from the hardware wallet device employing the private key;
d. seamlessly update the hardware wallet device of the transaction; and
e. display a real-time update of a balance of a plurality of cryptocurrencies in the hardware wallet device on a dashboard, displayed on the computer or smartphone.

There is thus provided according to another embodiment of the present invention, a software product, the product configured for transacting cryptocurrency employing a multiple-cryptocurrency hardware wallet device, the product including a processor-readable medium in which program instructions are stored, which instructions, when read by a processor, cause the processor to;
a. activate the multiple-cryptocurrency wallet assembly, comprising a hardware wallet device and a computer or smartphone, using a secret offline phrase via the hardware wallet device;
b. calculate at least one private key;
c. perform a wireless cryptocurrency transaction to or from the hardware wallet device employing the at least one private key;
d. seamlessly update the hardware wallet device of the transaction; and
e. display a real-time update of a balance of a plurality of cryptocurrencies in the hardware wallet device on a dashboard, displayed on the computer or smartphone.

There is thus provided according to another embodiment of the present invention, a software product, the product configured for transacting cryptocurrency employing a multiple-cryptocurrency hardware wallet device, the product including a processor-readable medium in which program instructions are stored, which instructions, when read by a processor, cause the processor to;
a. activate the multiple-cryptocurrency wallet assembly, comprising a hardware wallet device and a computer or smartphone, using a secret offline phrase via the hardware wallet device;
b. calculate private keys;
c. perform a wireless cryptocurrency transaction to or from the hardware wallet device employing the private keys;
d. seamlessly update the hardware wallet device of the transaction; and optionally
e. display a real-time update of a balance of a plurality of cryptocurrencies in the hardware wallet device on a dashboard, displayed on the computer or smartphone.

There is thus provided according to another embodiment of the present invention, a system for storing and transacting a plurality of cryptocurrencies, the system including:
a. a plurality of wallets as described herein; and
b. a communication network.

There is thus provided according to another embodiment of the present invention, a system for storing and transacting a plurality of cryptocurrencies, the system including:
a. a plurality of hardware wallet devices as described herein; and
b. a communication network.

There is thus provided according to another embodiment of the present invention, a system for storing and transacting a plurality of cryptocurrencies, the system including:
a. a plurality of wallet assemblies as described herein; and
b. a communication network.

The present invention further provides a method which allows the use of a single pass-phrase to control and generate an unlimited number of private keys. In other words, when a user sets his/her secret phrase on the multiple cryptocurrency wallet (also termed herein “Bitfi hardware device”), every time he/she uses the phrase in the future, the device is operative to calculate the private keys for Bitcoin just as it would for Monero, even though the two currencies have completely different private keys.

The present invention further provides a method, which allows sharing of processing tasks with a server for crypto processing functions that the device either cannot handle on its own or that would slow down the device and make it difficult to use. For example, when the device of the present invention calculates the Monero private key (after one enters one's secret phrase) the Monero algorithm is extremely complex and it would take the device up to 5 minutes to achieve the calculation on its own. However, the technology of the present invention enables a part of the calculation to be sent to a node (server) which runs the calculation in parallel with the device allowing the entire calculation to occur in less than 15 seconds, without compromising the safety or the security of the device.

The present invention further provides a VPN firewall, which runs in the background that prevents any other connections to occur with the node other than the intended functions of the device or wallet.

The present invention further provides a novel indexing system, described in further detail hereinbelow.

The present invention further provides a multiple cryptocurrency wallet or device. The wallet or device is run by a method of locally calculating private keys on the device so that the private key never needs to be stored anywhere, including the device itself. For example, if one's device is seized or stolen and taken apart, it is impossible to obtain or extract the private keys, thereby providing 100% security of the wallet and cryptocurrencies stored therein, in any situation.

The present invention further provides a protected system and method to provide secure, broad and rapid adoption to cryptocurrencies and crypto assets. As a foundation for anyone to fully participate in this market, it all starts with a 100% secure storage solution that is also markedly easy and intuitive to use. This level of security changes everything and allows users to fully step into the blockchain economy.

Compared to currently available devices such as Trezor, Ledger, and KeepKey, the hardware wallet of the present invention has numerous advantages. Rather than storing 24 random seed words, the wallet is set-up by the user using a single phrase. This phrase acts as both the seed and password and most users would not need to store or write down anything. In addition, all crypto assets can be viewed in one page via the wallet display control panel. Furthermore, all of this is performed with open source code so that users are not dependent on complex/multiple codes to access all their cryptocurrency assets.

Fortress-like security, of the system and wallets therein of the present invention, allows anyone to store unlimited amounts of crypto assets without any possibility of loss on the wallets of the present invention.

The hardware wallet of the present invention is a result of hundreds of hours of research and development, which is intended to solve all the weaknesses and security flaws of currently available prior-art devices.

It is both the most secure solution and the easiest to use. By offering impenetrable security, individual users and financial institutions can store unlimited amounts of cryptocurrency without any risk of loss in a completely trustless system without any reliance on third parties. Users' funds remain safe forever even if the current inventors are not available or the applicant is no longer active.

The hardware wallets of the present invention are both logical and progressive in comparison to prior-art wallets.

The hardware wallets of the present invention are intended to enhance and develop an emerging decentralized digital asset economy.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood. With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic illustration showing a system for cryptocurrency storage and use, in accordance with an embodiment of the present invention;

FIG. 1B is a simplified schematic illustration showing a wallet assembly including a wallet device for cryptocurrency storage and use, in accordance with an embodiment of the present invention;

FIG. 2 is a simplified flow chart of a method for activating a personal cryptocurrency wallet, in accordance with an embodiment of the present invention;

FIGS. 3A-3B are simplified pictorial illustrations showing a hardware wallet device for cryptocurrency storage and use, in accordance with an embodiment of the present invention;

FIG. 4 is a screen shot of a dashboard on a mobile communication device (smartphone) or computer, in accordance with an embodiment of the present invention;

FIG. 5 is a simplified pictorial illustration showing an internal rear view of a hardware wallet device, in accordance with an embodiment of the present invention;

FIG. 6 is a simplified flow chart of a method for activating a personal hardware wallet device, in accordance with an embodiment of the present invention;

FIG. 7 is a simplified flow chart of a method for performing a cryptocurrency transaction using a hardware wallet device, in accordance with an embodiment of the present invention; and

FIGS. 8A-8I are screenshots from the hardware device wallet screen or wallet dashboard, associated with the method of FIG. 7, in accordance with an embodiment of the present invention.

In all the figures similar reference numerals identify similar parts.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

A cryptocurrency is broadly defined as a digital currency in which encryption techniques are used to regulate the generation of units of currency and verify the transfer of funds, operating independently of a central bank.

A public key is a cryptographic code that allows a user to receive cryptocurrencies into his or her account. The public key, coupled with the private key, are significant tools required to ensure the security of the crypto economy.

A private key is a sophisticated form of cryptography that allows a user to access his or her cryptocurrency. A private key is an integral aspect of bitcoin and altcoins, and its security make up helps to protect a user from theft and unauthorized access to funds.

### Embodiments

1. A cryptocurrency wallet assembly for transacting a plurality of cryptocurrencies, the assembly comprising:
   a. a hardware wallet device comprising:
      i. an inputting means, adapted for inputting a secret phase;
      ii. a processor adapted to calculate at least one private key using an algorithm; and
      iii. means for connecting to a communication network; and
   b. a communication device comprising:
      i. a display for displaying a dashboard; and
      ii. a processor;

wherein said assembly is adapted to enable said cryptocurrency transactions in said plurality of cryptocurrencies to be performed safely and wirelessly over the communications network to and from said hardware wallet device.
2. A cryptocurrency wallet assembly according to embodiment 1, further comprising software for enabling said transactions via said communication device.
3. A cryptocurrency wallet assembly according to embodiment 1, wherein said hardware wallet device is configured to be activated via a dashboard on said communication device.
4. A cryptocurrency wallet assembly according to embodiment 2, wherein said secret phrase is operative to activate said hardware wallet device to calculate said at least one private key.
5. A cryptocurrency wallet assembly according to embodiment 4, wherein said at least one private key is operative to enable at least one cryptocurrency transaction.
6. A cryptocurrency wallet assembly according to embodiment 5, wherein said dashboard is adapted to display a real-time update of a balance of said plurality of cryptocurrencies in said hardware wallet device.
7. A cryptocurrency wallet assembly according to embodiment 1, wherein said plurality of cryptocurrencies comprises at least one of Bitcoin, Etherium, Monero, a privacy coin, a current cryptocurrency, a future cryptocurrency and combinations thereof.
8. A cryptocurrency wallet assembly according to embodiment 7, wherein said plurality of cryptocurrencies comprises all of Bitcoin, Etherium, Monero, a privacy coin, a current cryptocurrency, a future cryptocurrency and combinations thereof.
9. A cryptocurrency wallet assembly according to embodiment 1, wherein said hardware wallet device is configured to automatically update software on said device via said communications network.
10. A cryptocurrency wallet assembly according to embodiment 1, further comprising a firewall configured to block an unauthorized connection with said wallet from at least one of a node, a server, a second wallet, a wireless communication device, a wired communication device and combinations thereof.
11. A cryptocurrency wallet assembly according to embodiment 1, wherein said hardware wallet device further comprises a casing for housing said touchscreen display, said software and said Wifi connector.
12. A cryptocurrency wallet assembly according to embodiment 11, wherein said casing further comprises:
   a. an on/off button; and
   b. a USB port.
13. A cryptocurrency wallet assembly according to embodiment 1, wherein said secret phrase is provided on said hardware wallet device or said communication device.
14. A cryptocurrency wallet assembly according to embodiment 1, wherein said secret phrase is provided for a short period of time.
15. A method for transacting cryptocurrency employing a multiple-cryptocurrency hardware wallet device, the method comprising:
   a. activating the multiple-cryptocurrency hardware wallet device using a secret phrase on the wallet;
   b. calculating a private key; and
   c. performing a wireless cryptocurrency transaction from the hardware wallet device employing the private key over wireless communications network.
16. A method according to embodiment 15, further comprising:
   d. displaying a real-time update of a balance of a plurality of cryptocurrencies in the hardware wallet device on a dashboard.
17. A method according to embodiment 16, wherein said dashboard is displayed on a communication device.
18. A method according to embodiment 16, further comprising:
   e. seamlessly updating said hardware wallet device of said transaction.
19. A method according to embodiment 15, wherein said transaction is in one or more of plurality of cryptocurrencies selected form at least one of Bitcoin, Etherium, Monero, a privacy coin, a current cryptocurrency, a future cryptocurrency and combinations thereof.
20. A method according to embodiment 19, wherein said plurality of cryptocurrencies comprises all of Bitcoin, Etherium, Monero, a privacy coin, a current cryptocurrency, a future cryptocurrency and combinations thereof.
21. A method according to embodiment 15, further comprising automatically updating software running said hardware wallet device via said wireless communications network.
22. A method according to embodiment 15, further comprising blocking an unauthorized connection with said wallet from at least one of a node, a server, a second wallet, a wireless communication device, a wired communication device and combinations thereof via a firewall installed on said hardware wallet device.
23. A method according to embodiment 15, wherein said method further comprises sharing of processing tasks with a server for crypto processing functions so as to reduce a calculation time of said transaction.
24. A method according to embodiment 23, wherein said calculation time is reduced to less than one minute.
25. A method according to embodiment 24, wherein said calculation time is reduced to less than 15 seconds.
26. A software product, said product configured for transacting cryptocurrency employing a multiple-cryptocurrency wallet assembly, the product comprising a processor-readable medium in which program instructions are stored, which instructions, when read by a processor, cause the processor to:
   a. activate the multiple-cryptocurrency hardware wallet device using a secret phrase via said hardware wallet device;
   b. calculate a private key; and
   c. perform a wireless cryptocurrency transaction to or from said hardware wallet device employing said private key.
27. A software product, said product configured for transacting cryptocurrency employing a multiple-cryptocurrency wallet assembly, the product comprising a processor-readable medium in which program instructions are stored, which instructions, when read by a processor, cause the processor to:
   a. activate the multiple-cryptocurrency hardware wallet device using a secret phrase via said hardware wallet device;
   b. calculate a private key;
   c. perform a wireless cryptocurrency transaction to or from said hardware wallet device employing said private key; and
   d. display a real-time update of a balance of a plurality of cryptocurrencies in said hardware wallet device on a dashboard displayed on a computer or communication device, in communication with said wallet.
28. A system for storing and transacting a plurality of cryptocurrencies, the system comprising:
   a. a plurality of wallet assemblies according to embodiment 1; and
   b. a communication network.
29. A cryptocurrency hardware wallet device for storing and transacting a plurality of cryptocurrencies, the hardware wallet device including;
   a. an inputting means, adapted for inputting a secret phase of a user;
   b. a processor adapted to calculate at least one private key using an algorithm; and
   c. means for connecting to a communication network to enable transactions to be performed wirelessly over the communications network to and from the hardware wallet device using said at least one private key.

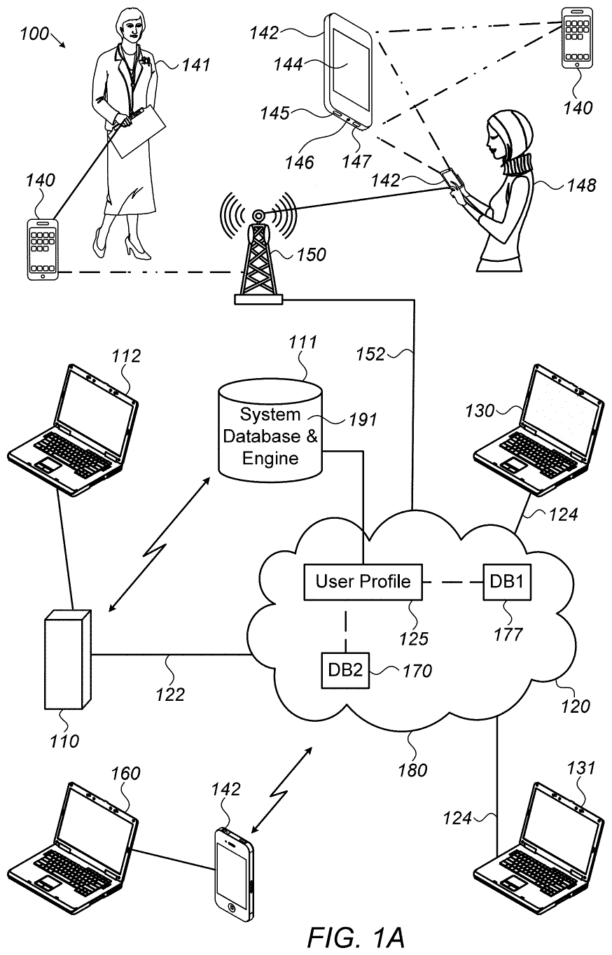

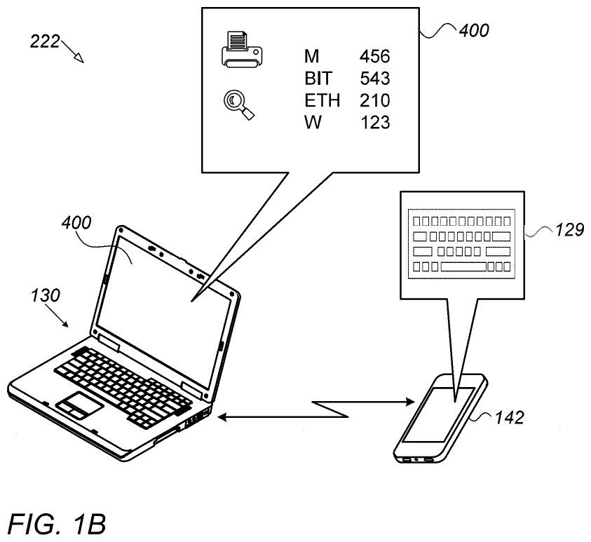

Reference is now made to FIG. 1, which is a simplified schematic illustration showing a system 100 for multiple cryptocurrency storage and use, in accordance with an embodiment of the present invention.

System 100 typically comprises a number of Bitfi multiple cryptocurrency wallets (hardware wallet devices) 142. Each wallet is associated with a user 148 and a computer 130, 160 and/or smartphones 140. The hardware wallet device has a screen (and/or keyboard or on-screen keyboard 129), (an optional charger socket 145, an optional headphone/microphone socket 146, an optional Wifi port 149, not shown) and a USB socket 147.

System 100 may include a server utility 110, which may include one or a plurality of servers and one or more control computer terminals 112 for programming, trouble-shooting servicing and other functions. Server utility 110 includes a system engine 111 and database, 191. Database 191 optionally comprises a user profile database 125, a first cryptocurrency database 170, a second cryptocurrency database 177, stored in a virtual cloud/on the internet 180.

Depending on the capabilities of a mobile device 140, system 100 may also be incorporated on a mobile device that synchronizes data with a cloud-based platform.

A support center may provide assistants 141 connected via his/her mobile device 140 to server utility 110. A user 148 may be connected by his/her laptop computer 130 (and/or via any other mobile/non-mobile communication device).

System 100 further comprises a virtual outputting module 185 for outputting data from the database via tweets, emails, voicemails and computer-generated spoken messages to the users, via the Internet 120 (constituting a computer network), SMS, Instant Messaging, Fax through link 122.

Users/customers 148 may communicate with server 110 through a plurality of user computers 130, 131, or user devices 140, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein.

Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices/computers and portable and mobile communication devices—and a variety of others such as an interactive television system may also be used.

The system 100 also typically includes at least one call and/or user support center 160. The service center typically provides both on-line and off-line services to users. The server system 110 is configured according to the invention to carry out the methods of the present invention described herein.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 100. Memories may be on a physical server and/or in a virtual cloud.

A mobile computing/communication device may/may not also embody a non-synced or offline copy of memories, copies of pathway cloud data, user profiles databases, cryptocurrency databases etc. Some parts of the system engine may be executed locally.

Reference is now made to FIG. 1B, which is a simplified schematic illustration showing a wallet assembly 222 including a (Bitfi) hardware wallet device 142 and a computer 130 (or smartphone 140) for cryptocurrency storage and use, in accordance with an embodiment of the present invention.

The term “wallet assembly” means a multiple cryptocurrency wallet including at least one communication device 140, 130 and one hardware wallet device 142.

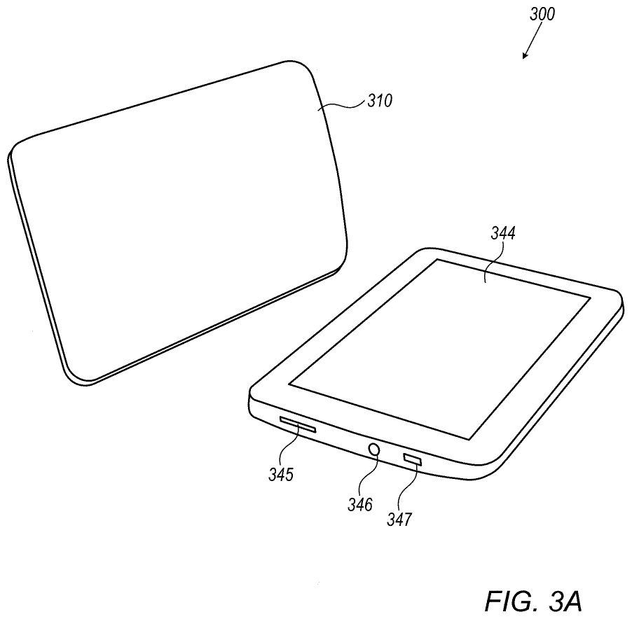

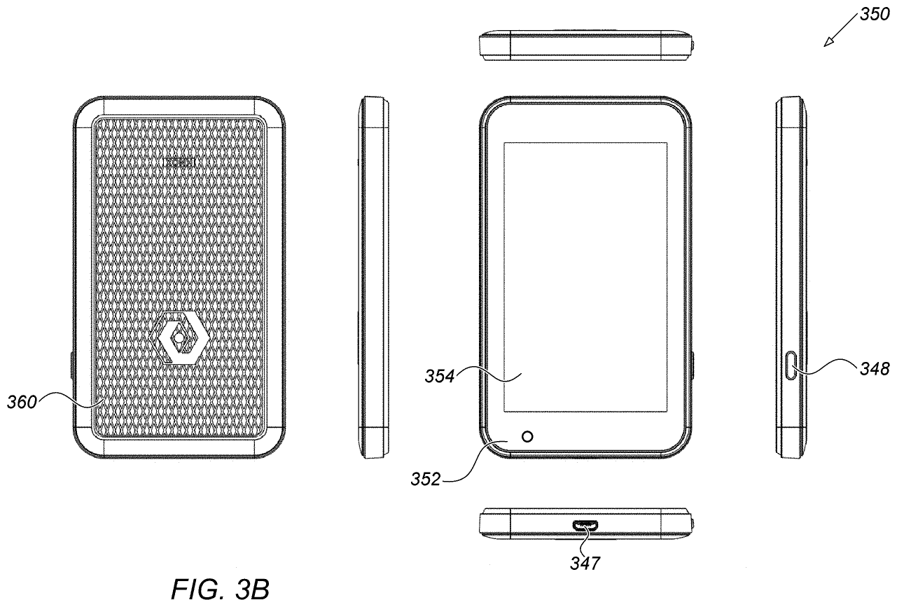

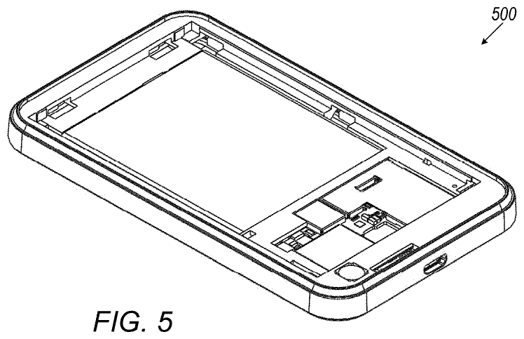

The term “hardware wallet device”, refers to the device shown in FIGS. 3A, 3B and FIG. 5, configured for secure storage of multiple cryptocurrencies.

The hardware wallet device is used to approve transactions, whereas, a dashboard displayed on the communication device is used to perform the transactions. However, the transactions cannot be completed without authorization and approval from the hardware wallet device.

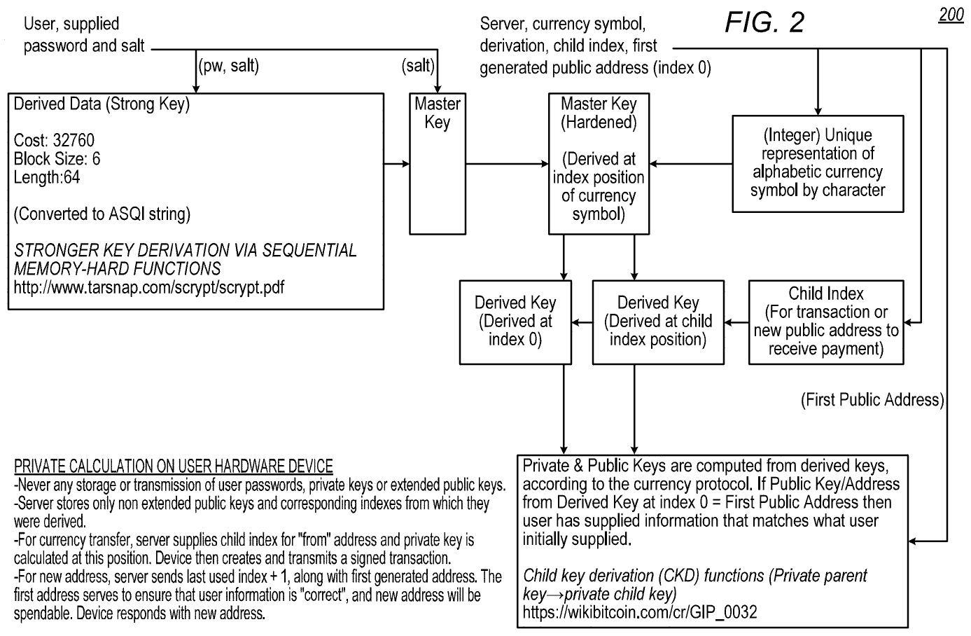

Reference is now made to FIG. 2 is a simplified flow chart 200 of a method for activating a personal cryptocurrency wallet, in accordance with an embodiment of the present invention.

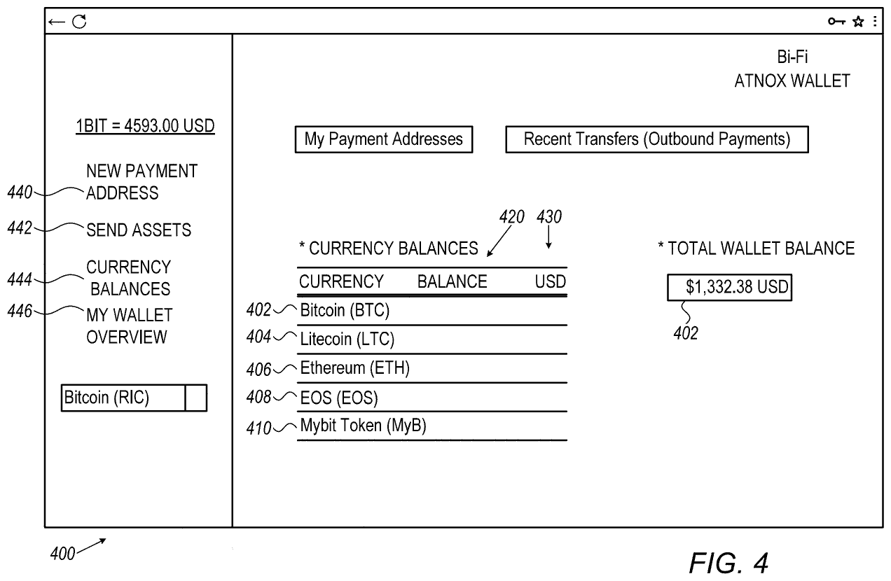

When user first receives brand new device, they follow a password setting procedure:
1) A user signs up on the display displaying a dashboard to create a new profile.
2) The dashboard is used to operate all the basic functions (like view balances, select currencies, check transaction history, etc. see screenshot, FIG. 4) while the hardware device is used for any secure functions or functions that require authorization (like sending money out).
3) The user then inputs an email address and establishes a password. When the user receives the device, the first thing is to synchronize the device with the dashboard is with the unique device ID code.
4) The user then enters this code into the dashboard (by clicking the “Sync Wallet” button).
5) Now the device and the dashboard established communication. Thereafter, when user clicks on “Add New Payment Address” for any currency on the dashboard, he/she receives a notification on the device to add a new address.
6) He/she enters the word “salt”, for example (salt is an anchor phrase like one's social security number or email address and unique passphrase).
7) The device then provides a message saying, “since this is the first address you have created, please repeat the salt and phrase exactly as entered”.
8) If the information is matched, it then creates a payment address for all available currencies on the dashboard.
9) It then creates a starting address for every single currency.
10) When future currencies are added to the dashboard (since the device is future proof), the device software is updated to support that currency (via a push notification from an outer node) and the user then needs to create a new address for that currency (if user wishes to use that currency).

Definition

Dashboard herein refers to a business intelligence dashboard, which is a data visualization tool that displays the current status of metrics and key performance indicators (KPIs) for an enterprise. Dashboards consolidate and arrange numbers, metrics and sometimes performance scorecards on a single screen.

In HD wallets, a key derived from a parent key. The key can be either a private key or a public key, and the key derivation may also require a chain code.

Synonyms

Child key

Child public key

Child private key

Not To Be Confused With

Public key (derived from a private key, not a parent key)

Links

Child key—Bitcoin.org Developer Guide

BIP32: Hierarchical Deterministic Wallets—Bitcoin Improvement Proposals

### ALGORITHM OF THE PRESENT INVENTION

The term “Bitfi” is used herein to denote the algorithms, devices, wallets and systems of the present invention.

Every cryptocurrency public address has a corresponding private key and that private key can originate from random data or other systems (like moving around a mouse to create randomness). In this invention, a user supplies a secret phrase and salt and from those characters (exactly as they are written). This supplies the entropy for his/her private key. This information alone returns a set of bytes and because one can have multiple addresses (for one currency like Bitcoin) additional entropy (or bytes of data) is derived from one's originating entropy, at a specific position. So just like in a computer where it gives a new random number, what it is doing is giving you a random number based on an originating point. In this case entropy is the secret phrase and additional bytes of data are derived from this. Knowing this starting point you can always know the next bytes of data.

Indexing System

Every payment address and its corresponding private key is generated from a set of bytes which are derived from one's entropy at a specific position (that is the index). The system node keeps track of which indexes are being used, so when a user sends money, the algorithm knows to do the same thing it did when it created this address, which is to derive a set of bytes from one's entropy at a specific index. So the algorithm knows at which index to derive a set of bytes from one's entropy, to be used for the private key corresponding to the addresses from which one is sending money. The indexing system of the present invention stores the indexes, which are in use. When a user adds a new payment address, it adds a new public address at the next position (index) in a certain order. In the case where a user has multiple addresses, in order to retrieve one's balance instead of querying each individual address from a node, they are queried as a group with all corresponding indexes. The reality is, the inventive method would not work if there wasn't another system keeping track of positions. By storing on a node, the positions are continuously tracked.

Method of Locally Calculating Private Keys

When one sends money, it is either one is sending money from a specific address or from a group of addresses, of the same currency. In every situation, where one intends to send money, the algorithm is informed of from which index it should derive bytes (from one's starting phrase). When it does this math, it obtains the right index and private key and signs the transaction. It does not need to be stored because it runs math same way every time.

Reference is now made to FIGS. 3A-3B, which are simplified illustrations showing a hardware wallet device 300, 350, for cryptocurrency storage and use, in accordance with an embodiment of the present invention.

Hardware wallet device 300 comprises a hard casing 310, a screen 344, an optional battery charger port 345, an optional microphone port 346 and a USB port 347. FIG. 3B shows a lower side of the wallet 350, an upper side 352, a screen 354, USB port 347 and an on/off button 348.

Reference is now made to FIG. 4, which is a screen shot of a dashboard 400 on a display of mobile communication device (smartphone 140) or computer 130 in FIG. 1, in accordance with an embodiment of the present invention. The screenshot shows a number of different cryptocurrencies, such as, but not limited to Bitcoin 402, Litecoin 404, Ethereum 406, EOS 408 and MyBit token 410. A balance 420 of each currency is tabulated, together with a total 430, providing a total wallet balance display 402.

The screenshot also provides icons, such a new payment address 440, send assets or money 442, currency balances 444 and my wallet overview 446.

Reference is now made to FIG. 5, which is a simplified pictorial illustration showing an internal rear view of a hardware wallet device 500, in accordance with an embodiment of the present invention.

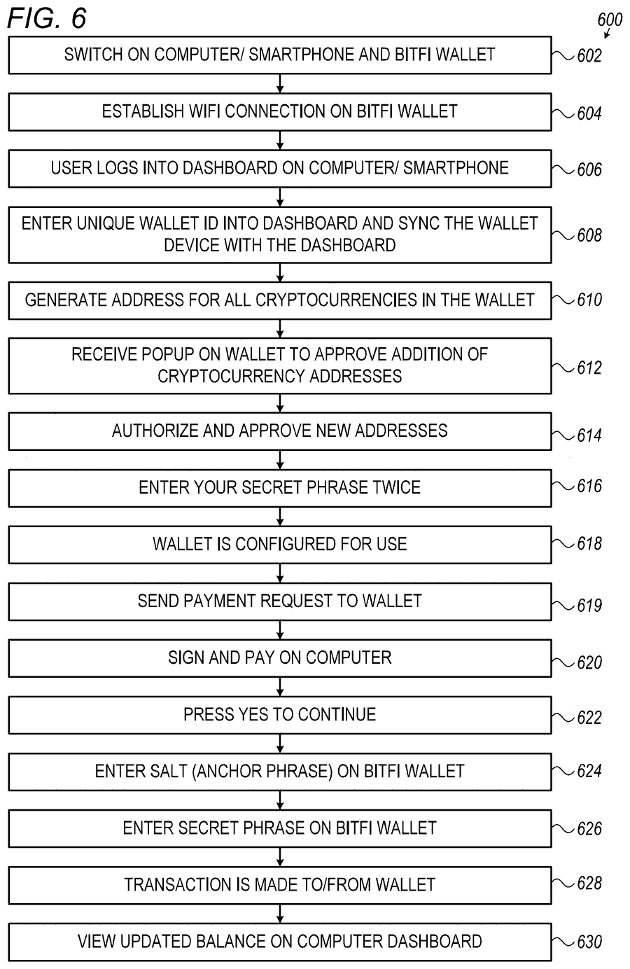

Turning to FIG. 6, there is seen a simplified flow chart 600 of a method for activating a personal hardware wallet device, in accordance with an embodiment of the present invention.

In a switching on step 602, the user switches on his computer 130, 160 and/or smartphone 140 and opens up the App/software (Bitfi.com website, for example), as well as switching on his/her hardware wallet device 142.

In an establishing a Wifi connection step 604, the user checks to see that the hardware wallet device is sufficiently close to the computer/smartphone to register to a Wifi connection.

In a logging on step 606, the user logs on to the dashboard 400 of the wallet assembly, such as by entering an ID number, email address, insurance number, passport number, similar user number and combinations thereof.

The hardware wallet device is synched with the dashboard in a synching step 608. Typically, this is performed by entering a unique wallet ID code into the dashboard on the screen of the computer/smartphone.

The system is then operative to generate addresses for all the cryptocurrencies (one for each cryptocurrency), stored in the wallet hardware device, in an address generating step 610.

The user then receives a popup on the dashboard to approve all the cryptocurrency addresses in an address popup approval step 612.

Thereafter, the user is requested to approve the new addresses in a user approval step 614.

The user enters his/her secret phrase twice to the hardware wallet device in a secret phrase entry step 616.

The user then receives a notification that the hardware wallet device is configured for use, in a notification step 618.

The user then sends a payment request 619 to the hardware wallet device in a payment request step 619.

The user signs and pays on the hardware wallet in a payment step 620 and presses yes to continue in a payment authorization step 622.

The user then enters a salt, such as an email address, in a salt entering step 624 on the hardware wallet screen and then a secret phrase in a secret phrase entry step 626.

The transaction is then performed to/from wallet in a cryptocurrency transaction step 628.

The user can then view an updated balance of all the cryptocurrencies, including the one transacted in step 628, on the dashboard, displayed on the screen of the computer or smartphone, in a multiple cryptocurrency balance viewing step 630.

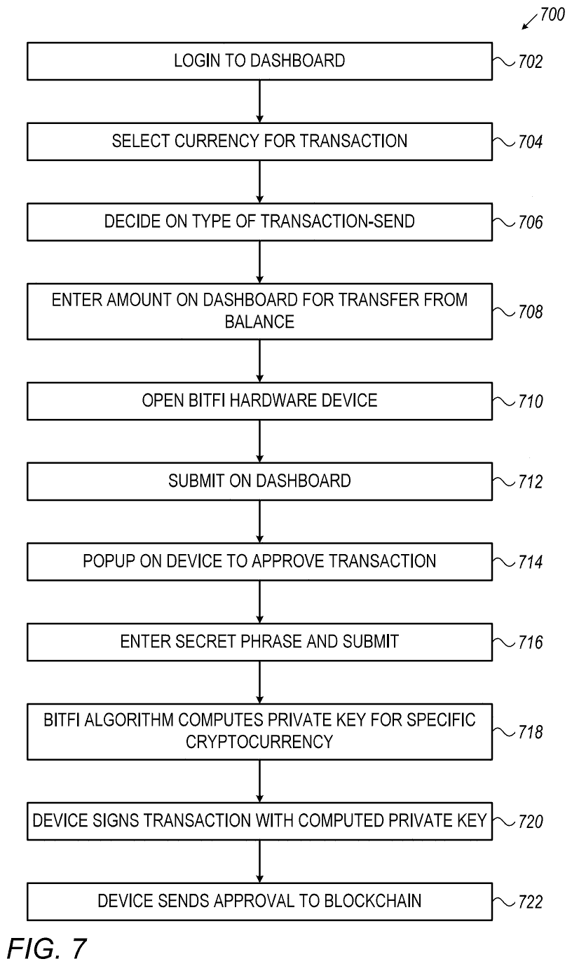

Reference is now made to FIG. 7, which is a simplified flow chart 700 of a method for performing a cryptocurrency transaction using a hardware wallet device, in accordance with an embodiment of the present invention.

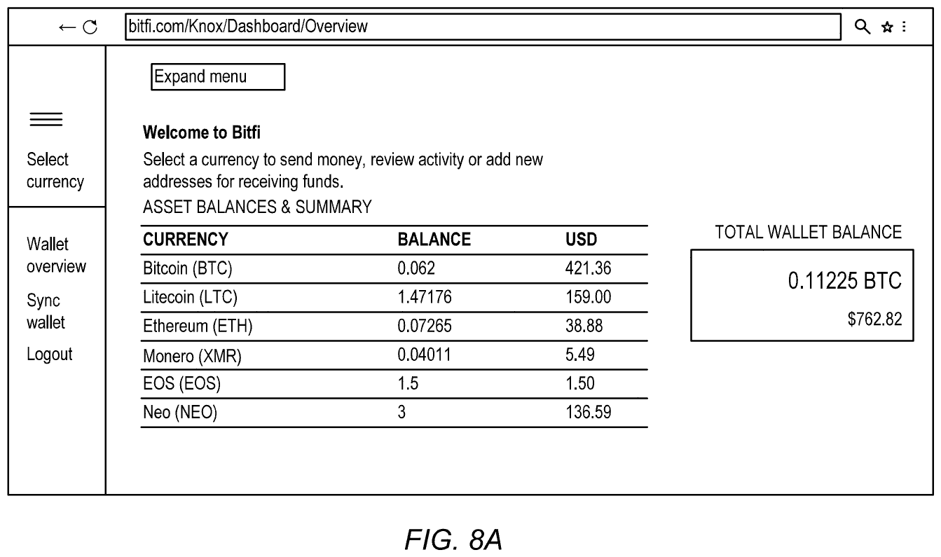

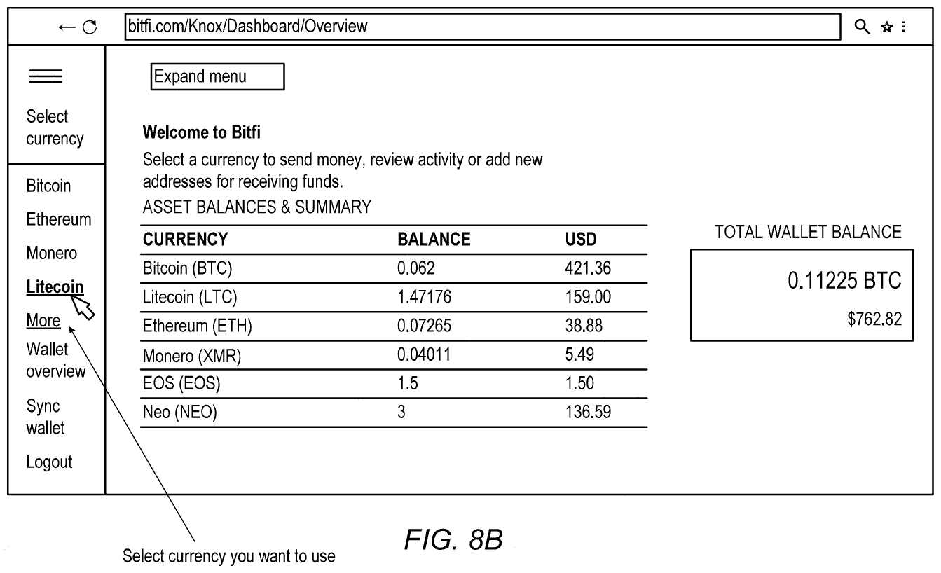

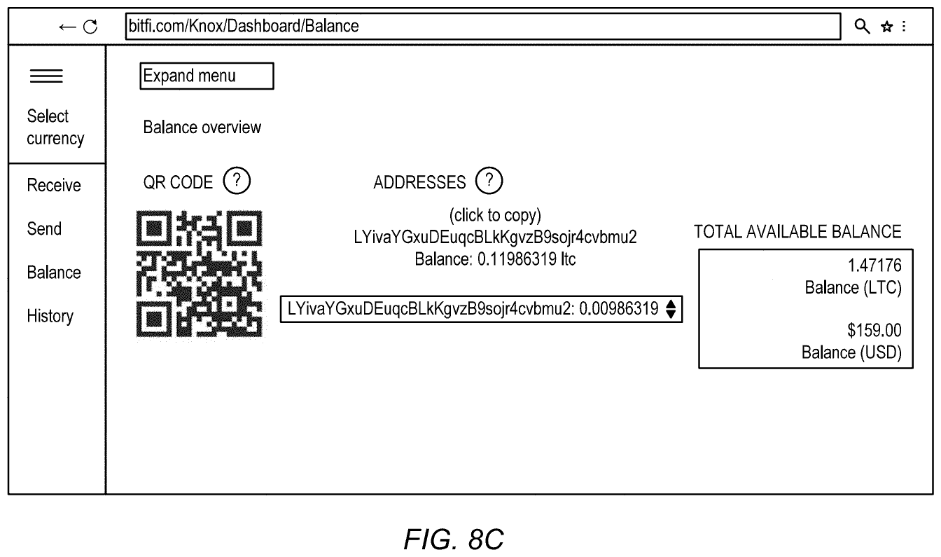

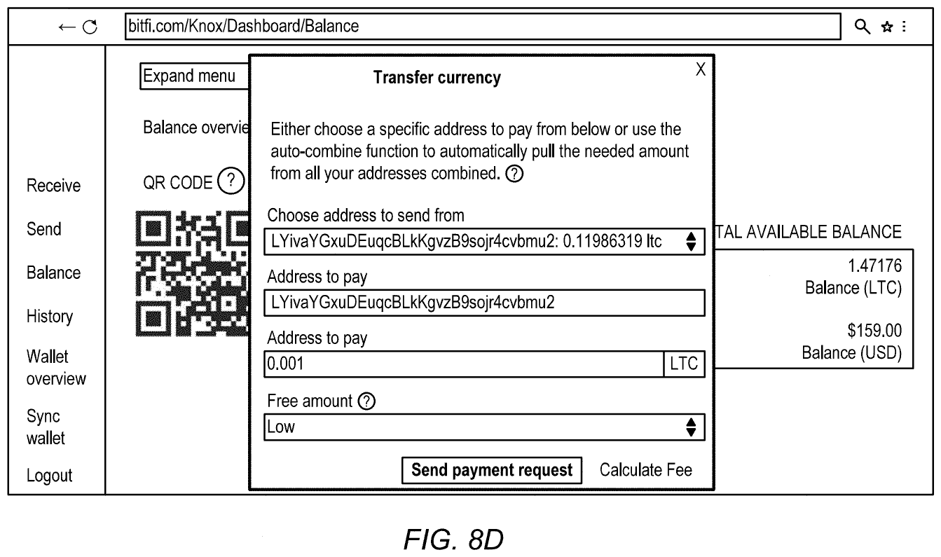

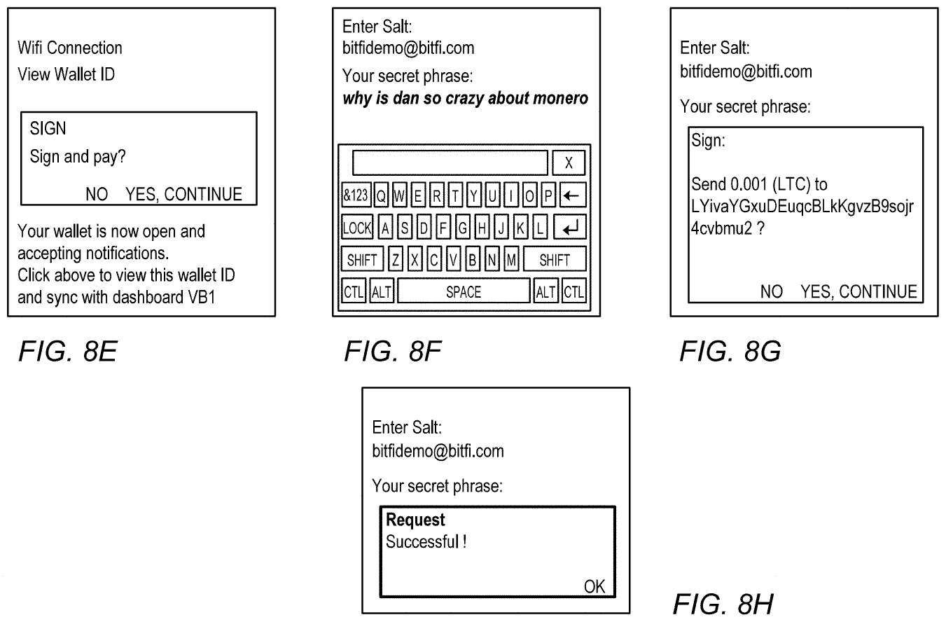

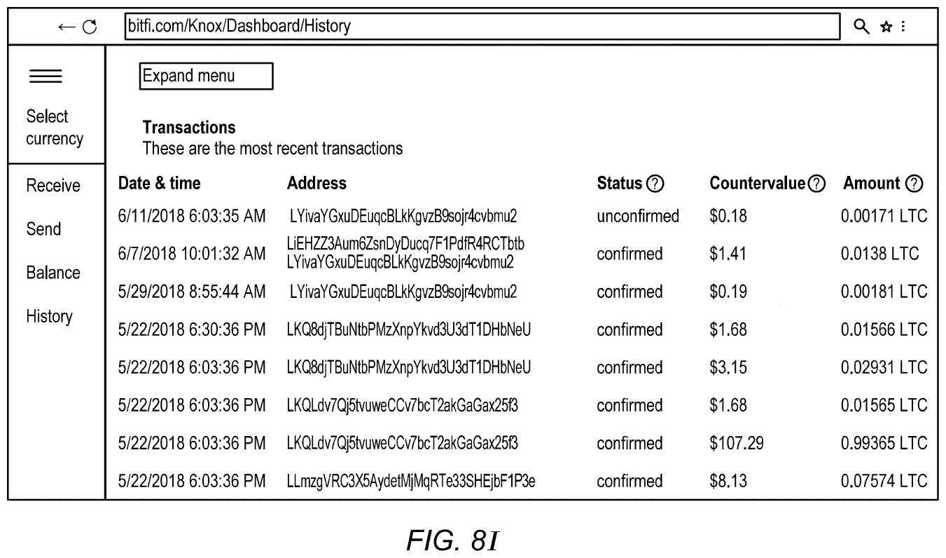

In a logging on step 702, the user logs on to the dashboard 400 of the wallet assembly, such as by entering an ID number, email address, insurance number, passport number, similar user number and combinations thereof (such as by going to bitfi.com/knox). The user can then view an updated balance of all the cryptocurrencies (400 FIG. 4, FIG. 8A), on the dashboard, displayed on the computer or smartphone screen.

The user selects one of the cryptocurrencies in a selecting cryptocurrency step 704 (FIG. 8B). Once he/she selects currency he/she wants, he/she opens the specific wallet (or folder) for that currency in the dashboard. It will look like FIG. 8C. This shows his/her balance and gives he/she the option to send, receive, and to also check his/her transaction history for that currency.

The user decides on the type of transaction, in a transaction selection step 706. This may be a selling, buying, sending, converting transaction, for example. If the user clicks send, this will open a pop-up to allow him/her to transfer currency from his/her available balance. In this window, he/she will be able to enter the address to which to send payment, enter the amount to be paid, and select the transfer fee of choice (options are low, medium, and high—a higher fee allows the transfer to go faster). These fees are set by the mining network (FIG. 8D).

For example in a transferring transaction, he she enters the amount of the cryptocurrency, which he/she wishes to transfer on the computer/smartphone screen displaying the dashboard, in an amount entry step 708.

The user then activates the hardware wallet device in a device activating step 710, as described above and makes sure that the Bitfi hardware device is turned on and connected to WiFi. Once he/she clicks “Send Payment Request” (as seen in attachment FIG. 8E), the user receives an instant pop-up on the Bitfi hardware device asking to approve the transaction. The user submits and approves the amount on the hardware wallet device in an amount submission step 712 (FIG. 8E).

If the user chooses to proceed with transaction, the device will ask him/her to enter in his salt (an additional anchor phrase which can be the user's phone number, social security number, or email address) and secret phrase. The hardware device uses the Bitfi algorithm to calculate the private key for this currency from the user's secret phrase using the onboard CPU (see FIG. 8F).

Once the user has entered the salt and secret phrase, the hardware device will show the summary of the transaction (address sending to and the amount being sent) and asking the user to confirm (FIG. 8G). A popup appears on the hardware wallet device, asking the user to approve the transaction in a popup step 714. If the user approves, he/she enters yes (FIG. 8G) on the hardware wallet device.

Once he/she submits his/her secret phrase in a phrase entry step 716, the hardware wallet device uses the Bitfi algorithm to calculate the user's private key for this cryptocurrency, sends the approval to the blockchain, and indicates the status of the transaction. (FIG. 8H).

The system (Bitfi) algorithm computes a private key for that specific cryptocurrency in a private key calculation step 718.

The device signs the transaction with the private key and notifies the user of the transaction success in a transaction signing step 720.

The device is then operative to send approval to the blockchain in a blockchain approval sending step 722.

The user can then view his balance of all the cryptocurrencies on the computer screen displaying the dashboard (FIG. 8I). The funds have now been sent and the private keys never left the device and are not stored on the device. The private keys are always calculated when they are needed from the user's secret phrase. He/she can now click on “History” in the Dashboard to view the transaction he/she just sent (FIG. 8I)

Hardware wallet devices of the present invention have no need to download anything, ever (Push Notifications).

The system of the present invention is configured both with a high level of security and is simple to use. These advantages of the system alleviate the requirement for a high level of technical skill (where even if the underlying technology is secure, this would be a security breach because funds could be lost due to user error). Countless people every day lose crypto assets in prior-art systems, because they pressed the wrong button or did not understand the feature they were using. Therefore, the multiple cryptocurrency system, method, wallet and software provide impenetrable security as an inseparable duality of a robust design and user friendliness.

Using the Bitfi wallet requires absolutely no technical skill and in fact you never even have to download or install any applications on one's computer or hardware device (multiple cryptocurrency wallet). One's device automatically has all of the latest updates and features because it receives software updates directly from the system server in real-time. This completely eliminates the possibility that a user may download corrupt software or accidentally downloads an update from the wrong location. The result is that:

1.) At all times, the wallet has all of the latest features without ever having to look for and update software;

2.) The present invention system is operative to eliminate any possibility of phishing attacks or corrupt software;

3.) The system of the present invention is operative to automatically add support for more/new cryptocurrencies and crypto assets. As they become available they automatically appear in one's wallet. The user never has to check any website for updates or download anything. This also means that a single purchase of a Bitfi wallet will continue to be automatically updated with the latest technology (thus one's device never becomes outdated or obsolete). This is a great long term investment and Bitfi continues to ensure that a user's wallet contains the latest cutting edge security and protection.

The systems for multiple cryptocurrency storage and use of the present invention also provide a user with a secure method for backing-up his/her hardware wallet device with a single secret phrase, with no need to write anything down.

In sharp contrast, virtually all available prior-art wallets require a back-up of the wallet with a 24-word mnemonic seed. The user is asked to write down the 24 random words and then store them in a safe place to be used in the future in the event a wallet is lost and requires recovery. This is a flawed approach and constitutes a potential security breach in prior-art systems. Anyone who is in possession of these 24 words is in control of the funds stored in the wallet. Any time that one writes down these words and stores them somewhere, there is potential exposure to risk. No matter how secure the location or hiding place, there is always a possibility that someone can find the seed phrase and take over the funds, stored in the wallet.

There is also the possibility of fire, theft, water damage, decay and many other events that can trigger a total loss of funds stored in prior-art wallets.

The present invention provides a truly secure cryptocurrency wallet, which allows the user to store an unlimited amount of funds without any risk or possibility of loss. To increase security to this level, the Bitfi Knox wallet is controlled and backed-up using a single secret phrase which gives users the option to commit the phrase to memory without the need to write anything down.

The result is that:

The wallet is controlled and backed-up using a single phrase (there is no separate password or pin-code and mnemonic seed of which the user needs to keep track).

The phrase is user created in such a way that it is impossible to guess but is also easy to commit to memory. For example, a possible phrase can be “10 Scary Things My Doctor Is Not Telling Me” or “WhyDoesShakespeareLoveMonero”.

The wallet of the present invention also requests that a user enters a second anchor such as a phone number, social security number, or email address or “salt”. This ensures that no two users can ever end up with the same phrase.

If a wallet is ever lost or stolen or even if Bitfi is no longer in business, one can easily recover one's funds using the system's open-source code.

Of course the user still has the option to write down and store their secret phrase if desired and in some environments or situations this may be appropriate. However, many users will enjoy the highest level of security knowing that their funds are stored without any potential security flaws. While these situations are rare; if one is a victim of theft, fire, or some other emergency, one's funds are always secure without any possibility of loss. No matter what happens, one's entire net worth is safely stored in one's secret phrase. A private key is not stored anywhere, ever.

Conventional prior-art hardware wallets store the private key (and this is what controls all the funds in one's wallet) on a device outside the computer. The device is then connected to a computer with a cable so that the device can approve transactions without the private key entering the computer environment where it can be stolen by hackers or malware. While this is an improvement over digital wallets that store the private key on ones' computer or smart phone, the private key is nevertheless stored on the prior-art device. This creates yet another security breach that leaves one's crypto assets vulnerable. If one's device is stolen or seized, it is possible for an attacker to obtain one's private key with forced entry using sophisticated tools available in modern labs.

The best solution is to not store the private key anywhere, in the first place. On the wallet for multiple cryptocurrency storage and use of the present invention (Bitfi Knox wallet), a private key is calculated using an algorithm, every time one types in one secret phrase. Once a transaction is approved, the private key is not stored anywhere in local memory. The private key does not exist on the device until one types in one's secret phrase again. Therefore if one's device is stolen or seized, there is no way to gain access to the private key because it is not on the device and one's funds always remain safe and there is absolutely no reason for alarm or concern if one's device is lost or stolen.

The systems of the present invention enable a user to view all of his/her funds and crypto assets in a single dashboard, displayed on a screen on a mobile device or computer.

Instead of having to access individual folders for each currency, one views all currencies and controls all one's digital assets in a single dashboard (on a computer/mobile device display). This is a natural and intuitive way to interact with one's money and to keep track of how much one has. If one has used a hardware wallet before, one probably felt the frustration of viewing the Bitcoin balances, but then having to close the wallet because one needs to access one's Litecoin and then having to open a dozen different applications and individual wallets to know what one's total assets are at the current time.

Other than offering high security and ease of use, managing one's money is efficient and productive, employing the wallets of the present invention. With the Bitfi wallet, one can view all of one's balances at a glance and quickly switch from one cryptocurrency to another, whether for personal or business use. The intuitive interface allows one to interact with all of one's assets in a simple and convenient manner, much like when using an ATM machine or when one logs into one's bank account, everything is clear and easy to navigate.

Native Support for Ethereum ERC20 Tokens

If one has used other prior-art hardware wallets, then one knows how intimidating and frustrating it can be (sometimes it feels like one needs a PhD in computer science). For example, one opens one application to view an Ethereum balance in a prior-art wallet, but then one has to go to MyEtherWallet.com to access one's Ethereum tokens. Since ERC20 tokens now account for some of the most valuable and important crypto assets, this is not a commensurate solution and a potential security breach (due to possible user error).

In sharp contrast, there is no need to connect prior-art of the present invention to MyEtherWallet.com to store Ethereum tokens like EOS. The systems of the present invention including a plurality of multiple cryptocurrency hardware wallets (Bitfi Knox) provides support for Ethereum tokens and they appear on the screen/display displaying a dashboard of the user wallet, together with all other cryptocurrencies.

Bitfi Knox wallet is completely wireless.

There is no need to connect one's Bitfi Knox to computer with a cable. Wherever one is, one's wallet always works wirelessly over any WiFi. No more messy wires. Bitfi is fast, really fast. As part of the ongoing program to support the users, the system of the present invention provides ongoing services to the users via displays on their wallets. The system of the present invention brings together the best technical resources without charging any subscription fees. The wallet display/dashboard rapidly scans all blockchains to show one's balances and is regularly updated so that one's experience and interaction with one's crypto assets is always flawless and seamless. Indeed, this is the way it should be and ushers in the full promise and potential of the emerging crypto economy.

One of the most important missions of Bitcoin and other crypto-assets is to place the control over money into the hands of the individual and to end the reliance on third parties.

Therefore, any robust and ultimate wallet must be completely open source so that one continues to have control over one's funds even if the manufacturer of the wallet no longer exists. No matter what happens to Bitfi or to one's Bitfi wallet, one's funds are always safe.

One may, at any time, use one's secret phrase to calculate one's private keys, using the open source code published on GitHub or by going to the non-profit Bitfi Foundation at www.bitfi.org, which shows simple step-by-step instruction on how to obtain one's private keys and to access one's crypto assets.

The system of the present invention supports an unlimited number of cryptocurrencies and crypto assets and use thereof in a user's wallet.

Unlike ordinary prior-art hardware wallets, which are operative to store only a limited number of folders (which must then be deleted, and new ones installed, in order to view other cryptocurrencies), the Bitfi Knox wallet supports all currencies and assets in a single device, under a single secret phrase. As support is added for additional currencies and assets over time, they are to be supported by one's device, without the need for the user to do anything, download anything, or install anything. The user just continues to use his/her original secret phrase to control any new crypto assets that appear in his/her wallet displaying the dashboard, over time.

Thus, a user is able to view all of his/her balances on the web any time, even without a hardware wallet.

A user is able to view all of his/her balances and activities, including transaction history on his/her smart phone or computer any time, by accessing his/her dashboard, even if he/she does not have his/her Bitfi Knox hardware wallet at hand. The device/wallet is only used for transactions that require approval, such as, but not limited to, sending funds out of one's wallet or adding a new payment address (basically anything that requires a private key). Public data, such as one's balances are viewable any time in one's Bitfi wallet display displaying the dashboard. This increases productivity and allows one to get more use out of one's wallet.

The wallets of the present invention have no possibility of a man-in-the-middle attack.

Unlike other prior-art hardware wallets, which can be tampered with, one can purchase the Bitfi Knox hardware wallet anywhere, without any risk. You can even purchase and use a preowned wallet without any security risks or vulnerabilities.

The Bitfi Knox hardware wallet is the world's first hardware wallet with support for Monero. Following Bitcoin, Monero (XMR) is perhaps the second most important cryptocurrency. It is the only true and fully decentralized private cryptocurrency, with no back doors.

However, Monero is built on a remarkably complex mathematical algorithm, which is why it has not had any wallet solution, despite being such a valuable cryptocurrency. The system of the present invention provides a hardware wallet with full support for Monero, with bullet-proof security and ease of use, as provided by Bitfi Knox. Now, anyone may own Monero and enjoy the benefits that it offers, coupled with the benefits of the user-friendly wallet of the present invention.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

Some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flow chart illustrations and/or block diagrams of methods, apparatus (systems) and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

The flow charts and block diagrams in the Figures illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustrations, and combinations of blocks in the block diagrams and/or flow chart illustrations, can be implemented by special purpose hardware-based systems that perform the specified functions or acts, or combinations of special purpose hardware and computer instructions.

Although the embodiments described above mainly address assessing test coverage of software code that subsequently executes on a suitable processor, the methods and systems described herein can also be used for assessing test coverage of firmware code. The firmware code may be written in any suitable language, such as in C. In the context of the present patent application and in the claims, such code is also regarded as a sort of software code.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims and all such claims that fall within the spirit of the invention.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

### REFERENCES

1. Percival, C. (2009). Stronger key derivation via sequential memory-hard functions. Self-published, 1-16. https://www.tarsnap.com/scrypt/scrypt.pdf
2. BIP 0032 https://en.bitcoin.it/wiki/BIP_0032
3. https://bitcoin.org/en/glossary/child-key

What is claimed is:

1. A cryptocurrency wallet assembly for transacting a plurality of cryptocurrencies, the assembly comprising:
a. a hardware wallet device comprising:
i. an inputting means, adapted for inputting a secret phase;
ii. a processor adapted to calculate at least one private key using an algorithm; and
iii. means for connecting to a communication network; and
b. a communication device comprising:
i. a display for displaying a dashboard; and
ii. a processor;
wherein said assembly is adapted to enable said cryptocurrency transactions in said plurality of cryptocurrencies to be performed safely and wirelessly over the communications network to and from said hardware wallet device.

2. A cryptocurrency wallet assembly according to claim 1, further comprising software for enabling said transactions via said communication device.

3. A cryptocurrency wallet assembly according to claim 1, wherein said hardware wallet device is configured to be activated via a dashboard on said communication device.

4. A cryptocurrency wallet assembly according to claim 2, wherein said secret phrase is operative to activate said hardware wallet device to calculate said at least one private key and wherein said wallet does not store said at least one private key.

5. A cryptocurrency wallet assembly according to claim 4, wherein said at least one private key is operative to enable at least one cryptocurrency transaction.

6. A cryptocurrency wallet assembly according to claim 5, wherein said dashboard is adapted to display a real-time update of a balance of said plurality of cryptocurrencies in said hardware wallet device.

7. A cryptocurrency wallet assembly according to claim 1, wherein said plurality of cryptocurrencies comprises at least one of Bitcoin, Etherium, Monero, a privacy coin, a current cryptocurrency, a future cryptocurrency and combinations thereof.

8. A cryptocurrency wallet assembly according to claim 7, wherein said plurality of cryptocurrencies comprises all of Bitcoin, Etherium, Monero, a privacy coin, a current cryptocurrency, a future cryptocurrency and combinations thereof.

9. A cryptocurrency wallet assembly according to claim 1, wherein said hardware wallet device is configured to automatically update software on said device via said communications network.

10. A cryptocurrency wallet assembly according to claim 1, further comprising a firewall configured to block an unauthorized connection with said wallet from at least one of a node, a server, a second wallet, a wireless communication device, a wired communication device and combinations thereof.

11. A cryptocurrency wallet assembly according to claim 1, wherein said hardware wallet device further comprises a casing for housing said touchscreen display, said software and said Wifi connector.

12. A cryptocurrency wallet assembly according to claim 11, wherein said casing further comprises:
a. an on/off button; and
b. a USB port.

13. A cryptocurrency wallet assembly according to claim 1, wherein said secret phrase is provided on said hardware wallet device or said communication device.

14. A cryptocurrency wallet assembly according to claim 1, wherein said secret phrase is provided for a short period of time.

15. A method for transacting cryptocurrency employing a multiple-cryptocurrency hardware wallet device, the method comprising:
a. activating the multiple-cryptocurrency hardware wallet device using a secret phrase on the wallet;
b. calculating a private key; and
c. performing a wireless cryptocurrency transaction from the hardware wallet device employing the private key over wireless communications network, wherein said wallet does not store said private key.

16. A method according to claim 15, further comprising:
e. displaying a real-time update of a balance of a plurality of cryptocurrencies in the hardware wallet device on a dashboard.

17. A method according to claim 16, wherein said dashboard is displayed on a communication device.

18. A method according to claim 16, further comprising:
f. seamlessly updating said hardware wallet device of said transaction.

19. A method according to claim 15, wherein said transaction is in one or more of plurality of cryptocurrencies selected form at least one of Bitcoin, Etherium, Monero, a privacy coin, a current cryptocurrency, a future cryptocurrency and combinations thereof.

20. A method according to claim 19, wherein said plurality of cryptocurrencies comprises all of Bitcoin, Etherium, Monero, a privacy coin, a current cryptocurrency, a future cryptocurrency and combinations thereof.
